(19) United States
(12) Patent Application Publication
(10) Pub. No.: US 2017/0185265 A1
(43) Pub. Date: Jun. 29, 2017

(54) Context Notification Apparatus, System and Methods

(71) Applicant: Motorola Mobility LLC, Chicago, IL (US)

(72) Inventors: William Pierce, Algonquin, IL (US); Michael Gunn, Barrington, IL (US); Andrew Wells, Lindenhurst, IL (US)

(73) Assignee: Motorola Mobility LLC, Chicago, IL (US)

(21) Appl. No.: 15/367,174

(22) Filed: Dec. 2, 2016

Related U.S. Application Data
(60) Provisional application No. 62/272,510, filed on Dec. 29, 2015.

(51) Int. Cl. G06F 3/0484; H04W 64/00; H04W 68/00; H04W 4/14; H04L 12/58

(52) U.S. Cl. CPC G06F 3/04842; H04W 4/14; H04L 51/04; H04W 68/00; H04W 64/006

(57) ABSTRACT

An apparatus includes a transceiver, a display, and a processor, operatively coupled to the transceiver and to the display. The processor is operative to interrupt a communication application by displaying a context notification within a graphical user interface (GUI) of the communication application on the display. The processor prevents user input to the communication application until a user selection input is received within the context notification on the GUI. In one embodiment, the processor is operative to display the context notification within a dialog box on the GUI.

### CROSS-REFERENCE TO RELATED APPLICATIONS

The present application claims priority to U.S. Provisional Patent Application No. 62/272,510, filed Dec. 29, 2015, entitled “CONTEXT NOTIFICATION APPARATUS, SYSTEM AND METHODS” which is hereby incorporated by reference herein in its entirety, and which is assigned to the same assignee as the present application.

### FIELD OF THE DISCLOSURE

The present disclosure relates generally to wireless communication devices and more particularly to conveying context information for such devices.

### BACKGROUND

Mobile devices such as smartphones provide various communication modes in addition to telephony capability. Included among these communication modes are video telephony, email, and text messaging capabilities such as short-message-service (SMS) and instant messaging (IM). Depending upon the user's environment and circumstances, invoking or responding to a given communication mode may be inappropriate or even dangerous. For example, receiving a phone call while driving could create a distraction and place the driver, passenger and others in an unsafe situation. Reading and replying to text messages while driving has been rendered illegal in most states because this irresponsible behavior creates a dangerous environment for the driver, surrounding vehicles and pedestrians and is akin to driving while intoxicated. In a noisy environment, such as a concert, having a phone conversation might be extremely difficult or impossible. Various other user environments and circumstances may render one mode of communication more appropriate than another at a given time.

### BRIEF DESCRIPTION OF THE DRAWINGS

FIG. 1 is a diagram of a context server operative to receive context information from a first mobile device and to send context notifications related to the first mobile device, to at least a second mobile device in accordance with the embodiments.

FIG. 2 is a message flow diagram of example messages and operations between a first mobile device, a server and two other mobile devices that are subscribed to a group for receiving context notifications related to the first mobile device, in accordance with an embodiment.

FIG. 3 is block diagram of a mobile device in accordance with an embodiment.

FIG. 4 is a set of example screen views illustrating context notifications displayed on a mobile device display in accordance with an embodiment.

FIG. 5 is an example of information contained in a client device groups and context database in accordance with an embodiment.

FIG. 6 is a flowchart of a method of operation of a mobile device in accordance with an embodiment.

FIG. 7 is a flowchart of a method of operation of a context server in accordance with an embodiment.

FIG. 8 is a flowchart of a method of operation in a mobile device in accordance with an embodiment.

### DETAILED DESCRIPTION

Briefly, a disclosed mobile device communicates with a server and receives context notifications related to a second mobile device and an associated second user. The notification message interrupts a communication application of the first mobile device when a first user attempts communication with the second user of the second mobile device using the communication application. A user selection input is required in the context notification before the first user can proceed with using the communication application. The user selection input may cancel the communication, proceed with the communication, or may launch an alternative communication application, which the first user may then invoke to communicate with the second user. The alternative communication application is a more appropriate communication mode based on the context of the second mobile device. A context server handles the context notifications sent to the mobile devices.

One disclosed embodiment provides an apparatus that includes a transceiver; a display; and a processor that is operatively coupled to the transceiver and to the display. The processor is operative to interrupt a communication application by displaying a context notification within a graphical user interface (GUI) of the communication application on the display. In some embodiments of the apparatus, the processor is further operative to prevent user input to the communication application until a user selection input is received within the context notification on the GUI. The processor may be further operative to display the context notification within a dialog box on the GUI. The dialog box may be an overlay, over the application GUI.

In some embodiments of the apparatus, the processor is further operative to interrupt the communication application where the communication application is being executed by the processor. The processor may interrupt the communication application in response to receiving the context notification from a server in some embodiments. The communication application may be, but is not limited to, a dialer, a short-message-service (SMS) application or an instant-messaging (IM) application. In various embodiments of the apparatus, the processor may be operative to display the context notification in a dialog box. The processor may display the dialog box overlaying the communication application GUI such that the communication application GUI cannot be accessed. In some embodiments, for certain use cases, the processor is further operative to clear the dialog box to enable access to the communication application GUI in response to user selection input within the dialog box.

In some embodiments of the apparatus, the processor is further operative to launch a different communication application from the interrupted communication application in response to the user selection input received within the context notification on the interrupted communication application GUI.

A disclosed method includes: interrupting a communication application running on a mobile device; and displaying a context notification within a GUI of the communication application on a display of the mobile device, where the context notification is interrupting the communication application. In some embodiments, the method further includes preventing user input to the communication application until a user selection input is received within the context notification on the GUI. The method may include displaying the context notification within a dialog box on the GUI. The method may include interrupting the communication application where the communication application is being executed by a processor of the mobile device. The method may include interrupting the communication application in response to receiving the context notification from a server. The method may include interrupting a communication application such as, but not limited to, a dialer, an SMS application or an IM application. The method may include displaying the context notification in a dialog box. The method may further include displaying the dialog box overlaying the communication application GUI such that the communication application GUI cannot be accessed. The method may include clearing the dialog box to enable access to the communication application GUI in response to user selection input within the dialog box. The method may include launching a different communication application from the interrupted communication application in response to the user selection input received within the context notification on the interrupted communication application GUI.

Another disclosed apparatus includes: a network interface, operative to implement an Internet Protocol (IP) connection; and a processor, operatively coupled to the network interface. The processor is operative to: receive modality information from a plurality of mobile devices; analyze the modality information of each mobile device to make a context inference for each mobile device; and send a context notification over the IP connection to subscribed mobile devices that are subscribed to receive context notifications from other mobile devices. In some embodiments of the apparatus, the processor is further operative to receive the modality information from a plurality of mobile devices, where the modality information includes sensor data from a plurality of mobile device sensors.

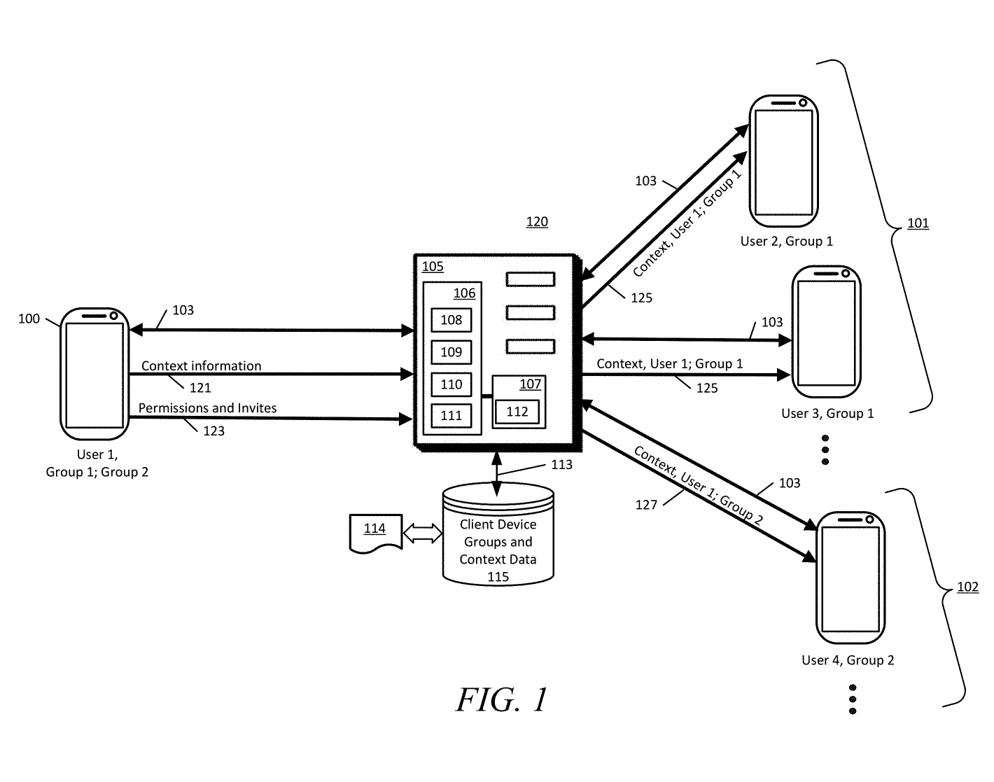

Turning now to the drawings, FIG. 1 is a block diagram of a context server 105 that is operative to communicate with various mobile devices to obtain context information and to send context notifications. The context server 105 is one type of apparatus of an embodiment and the various mobile devices are each another type of apparatus of the embodiments. The context server 105 along with the various mobile devices is one type of system according to the embodiments. In accordance with the embodiments, the context server 105 is located within a network, such as the Internet 120, and is accessible by various types of mobile devices. The mobile devices that interact with the context server 105 are subscribers to a context notification service provided by the context server 105 and are operative to send context information to the context server 105 and to receive context notifications from the context server 105. In operation, mobile devices are logged in to the context notification service as client devices and maintain a persistent Internet Protocol (IP) connection 103 with the context server 105.

The context server 105 may further be integrated with, or operatively coupled to, client device groups and context database 115. The context server 105 may access and communicate with the client device groups and context database 115 using any appropriate database access protocol 113. In some embodiments, the client device groups and context database 115 maintains client device context information and group association information and permissions in an information table 114.

In accordance with the embodiments, the context server 105 includes at least one network interface (not shown), at least one processor 106, and a nonvolatile, non-transitory memory 107 that is operatively coupled to the at least one processor 106. The non-volatile, non-transitory memory 107 stores executable instructions (executable code) 112 for a storage engine 108, context engine 109, notification engine 110 and a context notification application server 111. The processor 106 is operative to access the memory 107 and to execute the executable instructions 112 stored therein in order to implement the methods of operation of the context notification application server 111. The context notification application server 111 is operatively coupled, via application programming interfaces (APIs), to the storage engine 108, the context engine 109, and to the notification engine 110, and has read and write access to the client device groups and context database 115.

In one example of operation, a mobile device 100 maintains a persistent IP connection 103 with the context server 105 and sends context information 121. The mobile device 100 is subscribed to context notification group 1 and context notification group 2. In the example, the mobile device 100 is associated with a particular user and is identified by the context server 105 as “user 1.” The context notification groups, group 1 and group 2, are for the purpose of providing context notifications to other mobile devices where the context notifications are related to the context of mobile device 100. Accordingly, the first mobile device notification group 101 includes mobile devise that are subscribed to context notification group 1 and include, among other mobile devices, user 2 and user 3. A second mobile device notification group 102 includes mobile devices that are subscribed to context notification group 2 and include, among other mobile devices, user 4. The context server 105 acquires subscription information from the various mobile devices and stores the associations related to the various context notification groups within the client device groups and context database 115.

The various context notification groups may be established in various ways in accordance with the embodiments. In one example, the mobile device 100 may set up a context notification group with the context server 105 and may send group invitation messages to other mobile devices providing them the opportunity to join the context notification group. These invitation messages are shown as permission and invites messages 123. In that case, mobile devices that receive invitations may respond by sending a confirmation message back to the context server 105 which will, in response, update the client device groups in context database 115 accordingly to record the associations. In another example, a mobile device may send a request to the context server 105 to join a context notification group related to the mobile device 100. In that case, the context server 105 may send a permission request to the mobile device 100 over the IP connection 103. If the user of mobile device 100 wishes to include the requester in the context notification group, then the user may provide appropriate input to the mobile device 100 which will then send a permission and invites message 123 to the context server 105 granting permission for the requester to join the context notification group.

The mobile device 100 may specify to the context server 105, the specific context information that is allowed to be provided to particular context notification groups. In other words, the mobile device 100 may limit certain context information from being provided to particular context notification groups. For example, context notification group 1 may consist of coworkers that are allowed to receive context notifications during certain hours of the day that include working hours but are not allowed to receive context notifications during private time or during weekends. The context notification group 2 may consist of family members that are allowed to receive all context notifications during any hour and related to any activity.

Therefore in one example of operation, when the mobile device 100 sends context information 121 to the context server 105, in response, the context server 105 will send a first context notification 125 to user 2 and user 3, both of whom belong to context notification group 1, and will send a second context notification 127 to user 4 and any other users that belong to context notification group 2. The first context notification 125 and the second context notification 127 may include different information. For example the first context notification 125 may only contain a subset of the context information contained in the second context notification 127.

The context information 121 sent by the mobile device 100 to the context server 105 includes mobile device 100 modality information. The term “modality” as used herein refers to information that can be obtained by the mobile device 100 by way of various applications and sensors operational within the mobile device 100 that sense operating conditions of the mobile device 100 as well as external environmental circumstances or conditions. Examples of modality information may include, but are not limited to, sensor data, data regarding the state of applications being run on a mobile device, data regarding state of a battery, connectivity, and other information, etc. The term “context” as used herein is a broader term that encompasses modality and modality information and also includes a result or conclusion that may be drawn from analysis of the modality information to make an inference regarding the mobile device user's external environmental circumstances as well as operating conditions of the user's mobile device. Examples of context may include, but are not limited to, “walking,” “running,” “driving,” “in a noisy environment,” “in poor coverage area,” “low battery power,” “on public transportation,” “at location “x”,” “on a phone call,” “at work,”, “at school,” “in a meeting,” or other contexts, etc. that may be inferred using modality information.

In some embodiments, the context engine 109 obtains modality information as context information 121 from the mobile device 100 and applies a set of rules to make the inferences regarding the mobile device user's external environmental circumstances and operating conditions of the mobile device 100. In other embodiments, the mobile device 100 may include a context engine that performs the analysis of the mobile device 100 modality information, makes the inferences, and sends the conclusions as context information 121. Therefore in some embodiments, the context engine 109 may not be present in the context server 105. More particularly, only the notification engine 110 may be present in embodiments in which the context engine resides on the mobile device. However, in yet other embodiments, some mobile devices may include a context engine and the context server 105 may also include the context engine 109 that applies the necessary context rules to modality information received from other mobile devices that do not include a context engine. In other words, the analysis of modality information and generating a related context inference may be performed in a mobile device or in the context server 105, or in both in some embodiments.

The storage engine 108 gathers the context information 121, which may be only modality information from some mobile devices as discussed above, or may include the context inferences made by a context engine residing on the mobile device. The storage engine 108 is operative to communicate with the client device groups and context database 115 and store the context information 121 accordingly. The context engine 109 is operative to access the stored context information 121 to perform analysis to make context inferences as needed. The notification engine 110 is operative to send the context notifications to subscribed mobile devices, such as the first context notification 125 to notification group 101 and the second context notification 127 to notification group 102 as discussed with respect to the example provided above. The context notification application server 111 is operative to establish and set up the context notification groups, such as context notification group 1 and context notification group 2 discussed in the above example, and to receive permissions and invites 123 from the various mobile devices and to accordingly create the associations to the context notification groups within the client device groups an context database 115.

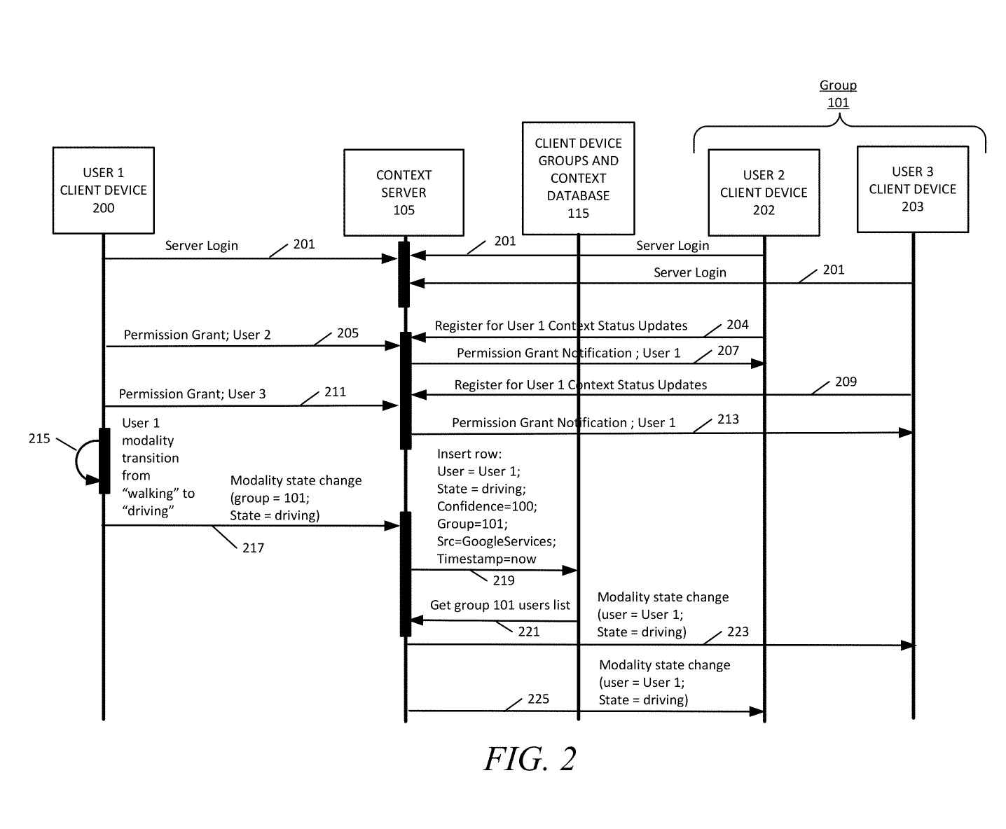

FIG. 2 is a message flow diagram of example messages and operations between a first mobile device (client device 200), the context server 105, client device groups and context database 115, and two mobile devices that are subscribed to the context notification group 101 for receiving context notifications related to the first mobile device, in accordance with an embodiment. Initially, each one of the mobile devices, designated in FIG. 2 as “client devices,” performs a server login 201 to the context server 105 and maintains a persistent IP connection. The example of FIG. 2 assumes that context notification group 101 already exists and that the context notification group 101 was established and set up by client device 200 using the context server 105. In that case, the client device 202 may send message 204 to the context server 105 in order to register for user 1 context notifications. The context server 105 will convey a permission request to client device 200 and user 1 may respond accordingly. The client device 200 will send the permission grant message 205 to the context server 105, and the context server 105 then sends message 207 to client device 202 with the permission grant notification from user 1. Likewise user 3, by client device 203, may send message 209 to the context server 105 to register for user 1 context notifications. The client device 200 may send permission grant message 211 for user three to context server 105, which will in turn send the permission grant notification 213 from user 1 to client device 203.

Subsequently, when the client device 200 has a modality transition 215 such as, for example, changing from walking to driving, the client device 200 will send a modality state change message 217 to the context server 105. The context server 105 will access the client device groups in context database 115 and will send the database update message 219 to update the information table 114. The database update message 219 may include information such as, but not limited to, the user identification, the state change, a confidence level, the group identification number and a timestamp. The context server 105 will also perform a get operation 221 to get the notification group 101 users list from the client device groups and context database 115. The context server 105 will then send the same context notification to both client device 202 and to client device 203 because both client devices are subscribers to context notification group 101. Therefore context notification 223 provided to client device 203 and context notification 225 sent to client device 202 contain identical information regarding context. In other words, client device 202 and client device 203 will receive an identical context notification message related to context notification group 101 which provides context notifications regarding user 1 (i.e. client device 200). Because the user 2 client device 202 and the user 3 client device 203 receive the context notifications that user 1 is driving, these client devices will provide further notifications to the user on their respective GUIs if user 2 or user 3 attempt to send a text message (SMS or IM) to user 1.

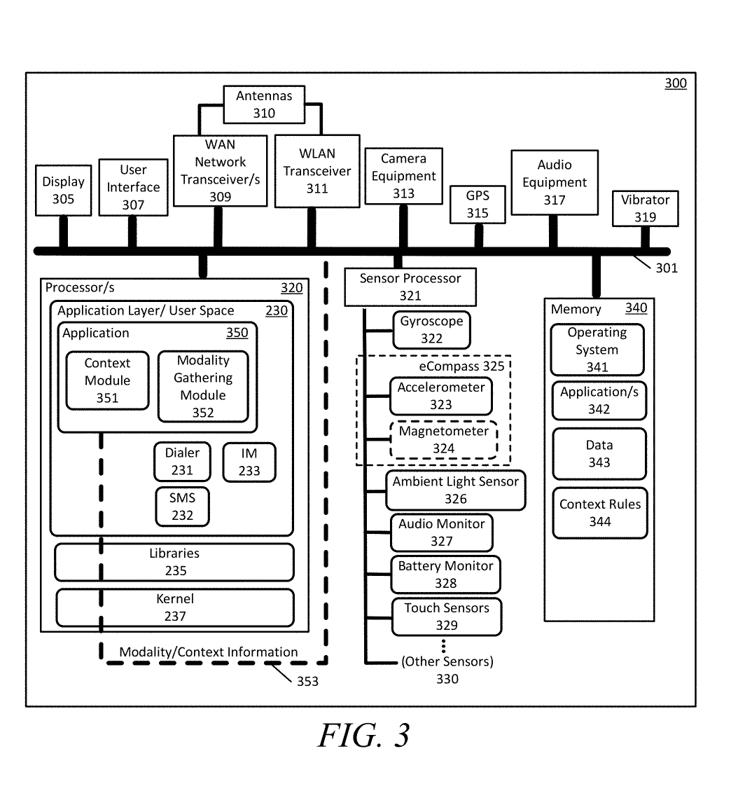

FIG. 3 is block diagram of an example mobile device 300 in accordance with an embodiment. The mobile device 300 includes a modality gathering module 352 and a context module 351, one or both of which may be implemented as an application 350 in some embodiments. One or both of the modality gathering module 352 and the context module 351 may be implemented as software or firmware (or as a combination of software and firmware) executing on one or more processors, and may also include, or may be implemented independently, using ASICs (application specific integrated circuits), DSPs (digital signal processors), hardwired circuitry (logic circuitry), or combinations thereof. That is, one or both of the modality gathering module 352 and the context module 351 may be implemented using an ASIC, DSP, executable instructions executing on a processor, logic circuitry, or combinations thereof.

In the example of FIG. 3, the modality gathering module 352 and the context module 351 are implemented as executable instructions (i.e. as application 350) stored in memory 340 and executed by processor 320. One or more internal connection buses 301 provide operative coupling between the processor 320 and the other various mobile device 300 components. As used herein, components may be “operatively coupled” when information can be sent between such two components, even though there may be one or more intermediate or intervening components between, or along the connection path. Therefore, any of the various components connected to the internal connection buses 301 may be understood herein to be operatively coupled to the processor 320 or to each other where appropriate. Operative coupling may also exist between modules or components implemented as software or firmware executing on a processor and such “software coupling” may be implemented using libraries 235 (i.e. application programming interfaces (APIs)) or other software interfacing techniques as appropriate. Such libraries or APIs are shown illustrated as providing operative coupling between various software implemented modules or components in FIG. 3.

The memory 340 is a non-volatile, non-transitory memory, and stores the executable instructions corresponding to various applications 342, and executable instructions corresponding to an operating system 341. The memory 340 may also store context rules 344 which may be used by a context engine to make inferences using modality information. The modality information may be stored as data 343 in memory 340. The operating system 341 executable instructions, when executed by processor 320, provide an application layer (or user space 230) for running the various applications, libraries 235 and a kernel 237 which provides interfaces to various hardware components of the mobile device 300. The processor 320 is operative to access the memory 340 and execute the stored executable instructions to perform the methods of operation disclosed herein as well as to perform other functions and operations such as running the mobile device 300 operating system, etc.

The mobile device 300 includes audio equipment 317 with one or more microphones (such as a microphone array) and a speaker. The audio equipment 317 may also include, but is not limited to, analog-to-digital converters (ADCs), digital-to-analog converters (DACs), echo cancellation, high-pass filters, low-pass filters, band-pass filters, adjustable band filters, noise reduction filtering, automatic gain control (AGC) and other audio processing that may be applied to filter noise from audio received using the one or more microphones. Some audio processing components of the audio equipment 317 may be single components or may be implemented partly in hardware and partly in software or firmware executed by processor 320. In some embodiments, some or all of the processing of the audio equipment 317 may be implemented using several hardware components and may also utilize one or more software or firmware components in various combinations. The audio equipment 317 may include a headset jack capable of connecting to a headset accessory via a wire. Alternatively, a headset accessory can wirelessly connect to an antenna of the mobile device to operatively couple the audio equipment 317. The headset accessory may also include a microphone component in some embodiments where the microphone is also operatively coupled to audio processing of the audio equipment 317.

The wireless wide area network (WAN) transceiver 309 provides wireless communication capabilities for one or more wide area network communications systems using any of various technologies such as, but not limited to, CDMA, UMTS, GSM, LTE, etc. and also provides Internet connectivity over the wireless interface to communicate with the context server 105. In some embodiments, a second wireless transceiver may also be present in the mobile device 300. The second wireless transceiver, WLAN transceiver 311, may provide wireless local area network connections, peer-to-peer connections, etc. and may provide wireless connectivity using technologies such as, but not limited to, WiFi®, Bluetooth®, Wireless USB, ZigBee, or other technologies, etc. The WLAN transceiver 311 may also provide Internet connectivity. Both the WAN transceivers 309 and the WLAN transceiver 311 are operatively coupled to antennas 310 which may include a single antenna, multiples antennas, an antenna array or some combination thereof.

Global Positioning System (GPS) hardware 315 is operative to provide location data such as, but not limited to, GPS coordinates to the processor 320 and to various applications. The user interface (UI) 307 may include a track ball mouse, touch sensitive elements, physical switches, gyroscopic position sensors, etc. Some of the UI 307 sensors may be included in a group of sensors (i.e. touch sensors 329, “other” sensors 330 or combinations thereof).

The mobile device 300 includes a vibrator 319 that may be set to vibrate in response to receiving a phone call, SMS message or other communication in lieu of sending a ring tone or other notification sound to a speaker of the audio equipment 317. The mobile device may also include camera equipment 313 as is familiar to most mobile device users.

A sensor processor 321 monitors sensor data from various sensors including a gyroscope 322, an accelerometer 323 and ambient light sensor (ALS) 326, an audio monitor 327, a battery monitor 328, touch sensors 329 (which may be capacitive sensors, photo sensors, or combinations thereof) as well as other sensors 330. The gyroscope 322 and accelerometer 323 may be separate or may be combined into a single integrated unit. In some embodiments, an eCompass 325 may include the accelerometer 323 along with a magnetometer 324.

The sensor processor 321 is operative to provide monitoring and data conversion functions for data received by the various sensors and to provide sensor data to the processor 320. For example, some of the sensors may be used by the UI 307 to receive user inputs. For example, the gyroscope 322 and accelerometer 323 may be used to determine the position of the mobile device 300 and to facilitate various forms of user input for various applications when a user moves the mobile device 300 into various positions, or tilts or shakes the mobile device 300. In one example, the display 305 may be adjusted by sensing the position of the mobile device 300 as being horizontal or vertical, shaken or tilted or combinations thereof etc. The other sensors 330 may include thermal sensors and other sensors that may be used by the processor 320 or various applications to adjust parameters of the mobile device 300 or for other purposes. The display 305 may be a liquid crystal display (LCD) and may provide a touchscreen capability that is part of the UI 307. The processor 320 is operative to control the display 305 to provide a graphical user interface (GUI) related to the mobile device operating system, a GUI related to one or more mobile device applications or both. The display 305 may therefore be considered part of the UI 307 in that it may be operative to receive command and control signals directly by touch. The audio monitor 327 is operative to obtain audio samples from the audio equipment 317 and to from time-to-time send the audio samples to the sensor processor 321. The battery monitor 328 is operative to monitor DC battery drain and to report on the health and power levels of the battery (not shown) from time-to-time to the sensor processor 321.

All sensor data sent to the sensor processor 321, and any touch data obtained through touchscreen capability of the display 305, is considered “modality information” and is accordingly collected by the modality gathering module 352. In some embodiments, the modality gathering module 352 may operate at the application layer of an IP protocol stack (not shown) executed by the processor 320 to facilitate IP communications with the context server 105. An API enables the modality gathering module 352 to communicate with one or more wireless protocol stacks (and corresponding transceivers) to send modality information to the context server 105 over a wireless interface using either WAN transceiver 309 or WLAN transceiver 311. The modality information may be sent to the context server 105 in response to detecting changes in the modality information.

The context module 351 is operative to communicate with the modality gathering module 352 and with the context server 105. The context module 351 is operative to interact with the display 305 and with various communication mode applications such as, but not limited to, a telephone dialer 231, IM application 233 and SMS application 232 and with associate GUIs to display context notifications. The context module 351 communicates with the notification engine 110 and the context notification application server 111, to receive context notifications related to other subscribers, and to establish and setup context notification groups and permissions for its own context information.

In some embodiments, the context module 351 may also include a context engine which is able to make inferences using modality information obtained by the modality gathering module 352. In that case, the context engine may use context rules 344 stored in memory 340, and apply the context rules 344 to modality information at appropriate times when modality information changes are detected by the sensor processor 321 and the modality gathering module 352. The context module 351 in that case can provide context inferences to the context server 105 instead of only sending modality information. Any information from the modality gathering module 352 or the context module 351 is communicated to one of the mobile device 300 transceivers over the internal connection buses 301 as modality/context information 353.

Any of the above described components, including “modules,” of mobile device 300 may be implemented as software or firmware (or a combination of software and firmware) executing on one or more processors, or using ASICs, (application-specific-integrated-circuits), DSPs (digital signal processors), hardwired circuitry (logic circuitry), state machines, FPGAs (field programmable gate arrays) or combinations thereof. Such software or firmware may be referred to herein as executable instructions or executable code and may be stored in non-volatile, non-transitory memory. Therefore the mobile device 300 illustrated in FIG. 3 is one example of a mobile device and is not to be construed as a limitation on the various other possible mobile device implementations that may be used in accordance with the various embodiments. In embodiments in which one or more components is implemented as software, or partially in software/firmware, the executable instructions may be stored in the operatively coupled, non-volatile, non-transitory memory 340, or in on-chip or on-die non-volatile, non-transitory memory (not shown), or combinations thereof, and may be accessed by the processor 320, or other processors, as needed.

Therefore, in one example embodiment, one of the modality gathering module 352 or the context module 351, or both, may be implemented as a combination of software and firmware) executing on one or more processors. In another example embodiment, one of the modality gathering module 352 or the context module 351, or both, may be implemented as an ASIC. In another example embodiment, one of the modality gathering module 352 or the context module 351, or both, may be implemented using a DSP. In another example embodiment, one of the modality gathering module 352 or the context module 351, or both, may be implemented using an FPGA. Other embodiments having other implementations are contemplated by the present disclosure.

The various embodiments also include non-volatile, non-transitory computer readable memory, other than memory 340, that may contain executable instructions (i.e. executable code), for execution by at least one processor, that when executed, cause the at least one processor to operate in accordance with the functionality and methods of operation herein described. The computer readable memory may be any suitable non-volatile, non-transitory, memory such as, but not limited to, programmable chips such as EEPROMS, flash ROM (thumb drives), compact discs (CDs) digital video disks (DVDs), etc., that may be used to load executable instructions or program code to other processing devices such as servers, mobile devices or other devices such as those that may benefit from the features of the herein described embodiments. For example, applications 342 executable instructions for the modality gathering module 352, the context module 351, or both, may be stored on any of the above described forms of computer readable memory, etc.

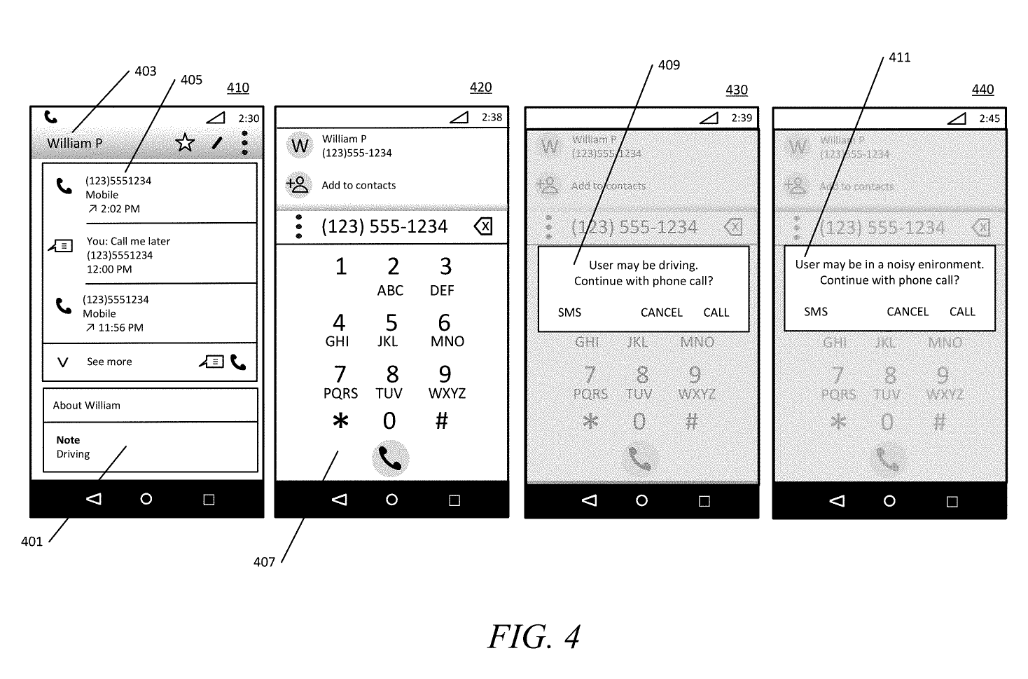

FIG. 4 is a set of example screen views illustrating context notifications displayed on a mobile device display in accordance with an embodiment. The context module 351 provides context notifications received from the context server 105 to other applications that may display the context notifications in various views. In view 410, the context module 351 provides context notification information to an address book application. In the address book application, a contact name 403 (“William P.”) is selected and is displayed on a mobile device display GUI along with communication information 405. The context module 351 provides context notification 401 information which is displayed in a notes field of the address book application. In the example view 410, the selected contact is indicated to be “driving” by the context notification 401 shown in the notes field.

In example view 420, the user has invoked the dialer 231 application in an attempt to place a telephone call to the contact selected in the address book. The dialer 231 application displays the dialer GUI 407 which shows the telephone number for the contact. The user may either enter a new telephone number or may select a contact from the address book and place a phone call by hitting the call icon button near the bottom of the dialer 231 GUI 407. If context notification information has been sent by the context server 105 to the context module 351 for the contact that the mobile device 300 user is attempting to communicate with, then an appropriate notification will be displayed by the communication mode application. In the example view 430, where the user has attempted to call the selected contact, the context module 351 will display a dialog box 409. In dialog box 409 the user is shown the context notification “User may be driving” and is queried as to whether the phone call should be placed or not. The dialog box 409 provides the user options to cancel the call (“CANCEL”), proceed with the call (“CALL”), or invoke the SMS application 232 (“SMS”) in order to place a text message as an alternative to calling.

In the example view 440, a dialog box 411 provides the context notification “User may be in a noisy environment” contact may be in a noisy environment and therefore would not be able to hear the phone call. The dialog box 411 also queries whether the phone call should be placed, and provides the option to cancel, proceed with the call, or invoke the SMS application 232. It is to be understood that similar dialog boxes would be displayed within the SMS application 232 or the IM application 233. For example, if the user attempted to send a text message to the contact using the SMS application 232, and if the contact was driving, a dialog box would be displayed with the context notification “User may be driving” and would provide options to cancel the SMS (“CANCEL”), send the SMS later when the contact context changes to a non-driving state (“DELAY SMS”), place a call (“CALL”), etc. That is, it is to be understood that the dialog boxes may present options other than, or in addition to, “SMS”, “CANCEL” and “CALL” in the various embodiments. It is also to be understood that the views shown in FIG. 4 are examples only and that the presentation of context notifications and dialog boxes may be presented and displayed differently depending on the GUI of the specific application that is being used in a particular embodiment.

As shown by the example views of FIG. 4, the context module 351 is operative to interrupt a communication application on a mobile device (such as, but not limited to, the dialer application 231, SMS application 232 or IM application 233) until a user selection input is received in response to the interruption. That is, a dialog box displayed on the mobile device display is used in some embodiments to interrupt a function of a communication application where the dialog box forces a user to provide selection input before proceeding with the application function or terminating the application, or launching a different application as an alternative to the interrupted application. In other words, the communication application may be considered paused until a user selection input is received within the dialog box. The dialog box is displayed within a GUI of the communication application. The term “within a GUI” as used herein means that the dialog box is displayed while the communication application GUI is active on the client device display. The dialog box is “within a GUI” when displayed as a graphics overlay, where it appears to float above the communications application GUI as shown in the examples of FIG. 4. The graphics overlay operation is handled by the client device processor. The communication application itself is not modified in order to display the graphics overlay of the dialog box. The dialog boxes, such as shown in the examples of FIG. 4, are provided by the application 350 shown in FIG. 3.

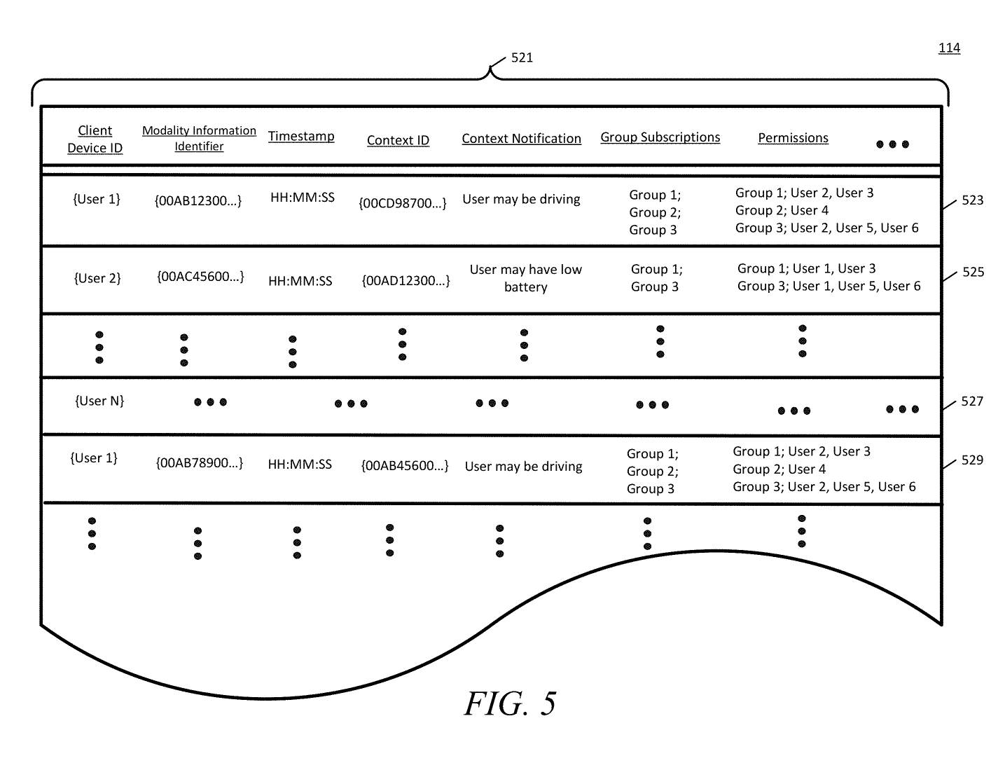

FIG. 5 is an example of an information table 114 that may be contained in a client device groups and context database 115 in accordance with an embodiment. The information table 114 is an example only and is for the purpose of describing some of the information contained in the client device groups and context database 115 and is not to be construed as a limitation on the data format, data structure or database techniques used in the various embodiments. In most embodiments, the client device groups and context database 115 will be a relational database with the database access protocol 113 using, but not limited to, Structured Query Language (SQL), Open Database Connectivity (ODBC), Java Database Connectivity (JDBC), or some equivalent, etc.

The context server 105 may use the example information, and any other information, contained in the information table 114 to keep track of various mobile devices as it receives corresponding, respective modality information or context information from each mobile device. The example information table 114 includes, but is not limited to, columns 521 including “client device ID,” “modality information identifier,” “timestamp,” “context ID,” “context notification,” “group subscriptions,” and “permissions.” The information table 114 may be handled by the context notification application server 111 component of the context server 105, in conjunction with the storage engine 108, context engine 109, and notification engine 110, each of which may provide inputs and derive outputs from the information table 114.

The “client device ID” column provides identification for the user of the respective mobile device so that modality and context notifications can be properly associated. The “modality information identifier” column provides a unique identification number assigned to a set of modality information received from a corresponding mobile device in order to prevent duplicate entry of data in the information table 114. The “timestamp” column provides further identification of received modality information. This is because modality information may be the same at given times and therefore the timestamp information is needed to distinguish between identical modality occurrences over time.

The “context ID” column provides a unique identifier for the context inference made by the context engine 109 using the modality information received from the mobile device. The “context notification” column provides the notification text that is presented to the mobile device user on the mobile device display at the appropriate time and within a GUI of an appropriate application such as was described by the example views shown in FIG. 4. The “group subscriptions” column provides the groups that the mobile device user has established or of which the mobile device user is a member. The “permissions” column provides information regarding the information that other users are allowed to receive as context notifications. Various other information columns may also be present in the information table 114.

Example row 523 shows example information for “user 1.” The “modality information identifier” and “context ID” are both shown as hexadecimal values for purposes of illustration but could be any type of computer storable value that may be used as an identifier. In some embodiments, the context notification application server 111 of context server 105 may request modality information or context information from a given mobile device. This information will then be stored by the storage engine 108 as modality information or context information in an appropriate data fields (not shown) associated with row 523. The timestamp column will be updated accordingly. If modality information is received, the context engine 110 will apply rules to the modality information and make a context inference, and a “context ID” associated with the context inference will be added to the appropriate column within row 523.

Some mobile devices may have multiple row entries in the information table 114. For example, “user 1” has a second entry at row 529 because the user 1 modality information changed. An example entry for “user 2” is shown at row 525. The information table 114 entries therefore continue to row 527 and beyond row 529 for “N” number of user mobile devices until the table is rolled or refreshed. In some embodiments, a mobile device row entry may be removed from the information table 114, or replaced, after new modality information from the user mobile device is received by the context server 105.

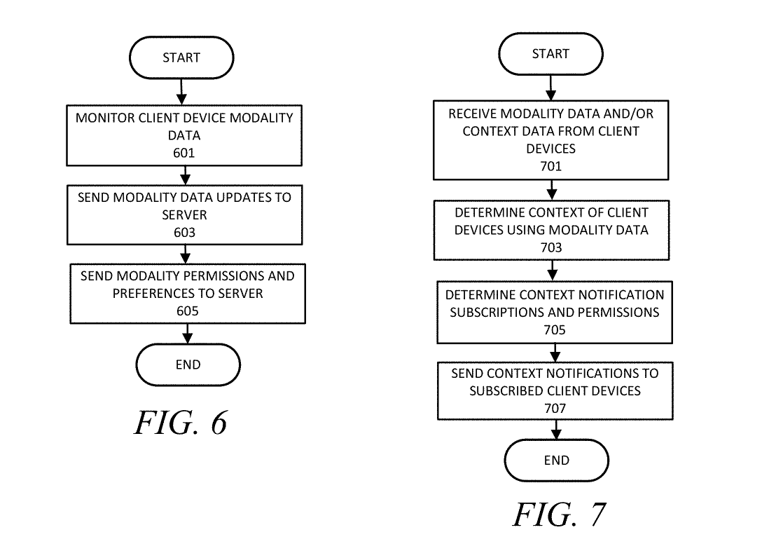

Examples of methods of operation of a mobile device and context server are described below with respect to flowcharts in FIG. 6 through FIG. 8. FIG. 6 is a flowchart of a method of operation of a mobile device in accordance with an embodiment. In operation block 601, the modality gathering module 352 will monitors client device modality data. The modality gathering module 352 may perform this operation by communicating with the sensor processor 321. In operation block 603, the modality gathering module 352 will send any modality data updates to the context server 105. In operation block 605, the context module 351 may send modality permissions and preferences to the context server 105.

FIG. 7 is a flowchart of a method of operation of a context server in accordance with an embodiment. In operation block 701, the context server 105 receives modality data, context data or both from various client devices. In operation block 703, the context engine 109 analyzes the modality data to infer contexts for each of the client devices that have sent modality information. In operation block 705, the context engine 109 determines what mobile devices have appropriate context notification subscriptions and permissions such that they may receive context notifications. In operation block 707, the context server 105 sends context notifications to subscribed client devices.

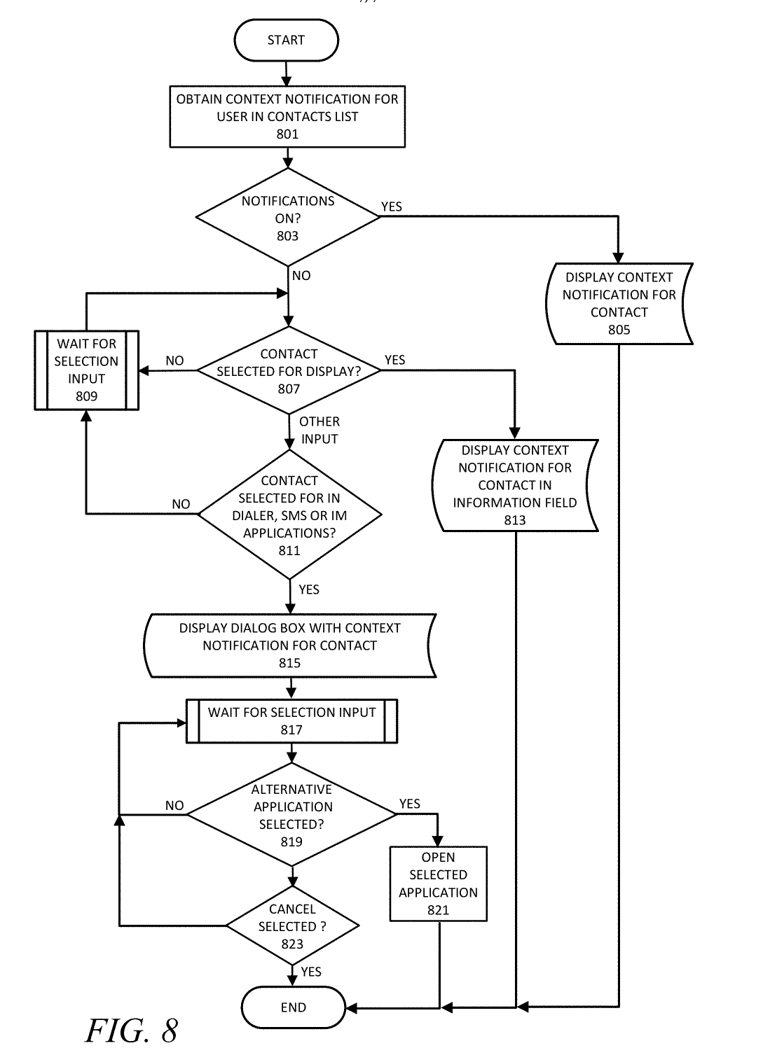

FIG. 8 is a flowchart of a method of operation in a mobile device in accordance with an embodiment. In operation block 801, context module 351 will obtain a context notification for a user in the mobile device 300 contact list (or address book), from the context server 105. If the mobile device 300 has notifications turned on in decision block 803, then in operation block 805 the context module 351 will display a context notification for the associated contact on the display 305. The method of operation then terminates.

However if notifications are not turned on in decision block 803, then in operation block 809 the context module 351 will wait for further input and will determine whether a contact associated with the context notification has been selected for display in decision block 807. If the contact has been selected for display in decision block 807 (by for example, selecting the contact from an address book), then in operation block 813 the context module 351 will display a context notification for that contact in an information field, a dialog box, or some other format, etc. One example of this operation is shown in view 410 where a context notification “driving” is displayed in the “notes” field for a contact selected from the address book. The method of operation then terminates as shown.

However if a contact has not been selected for display in decision block 807, then the context module 351 waits for selection input in operation block 809. If any other input is received at decision block 807, then in decision block 811 the context module 351 will determine the application with which it will have to interact if any. If no such other input is received at decision block 807 and/or decision block 811, then the context module 351 will wait for further selection input in operation block 809.

If an application is invoked in decision block 811, then in operation block 815 the context module 351 will display a dialog box with the context notification when appropriate within a GUI of the application. An example of this operation was described above with respect to view 430 and view 440 in which a user invoked the dialer 231 application and attempted to place a phone call to the contact. In those cases, the context module 351 displayed dialog box 409 or dialog box 411, respectively, in the corresponding example views.

In operation block 817, the context module 351 will wait for selection input made to the dialog box that it has displayed within the application GUI. In decision block 819, if an alternative application is selected from the dialog box, then the context module 351 will open the selected application as shown in operation block 821 and the method of operation will terminate as shown. Until an alternative application is selected in decision block 819, the context module 351 will wait for selection input in operation block 817. However if the user has canceled the attempted action from the dialog box in decision block 823, then the method of operation will terminate and the dialog box will be closed.

“Context notification” as referred to herein can take any of different forms and may provide various types of information about a mobile device user. As discussed above, a context notification is determined by the context engine 109 which analyzes modality information in order to make inferences about a given user's “context.” One example of such a context inference is the “driving” context. Modality information may indicate the position of a mobile device such as, for example, that the mobile device is placed on a flat surface with its display toward a surface and that it is also moving at a given rate of speed. In that case, the context engine 109 may make an inference that the mobile device is in a vehicle and is placed on a car seat or dashboard etc. The specificity of the context inferred may be related to the type and granularity of the modality information that is available from the mobile device.

For example, the context engine 109 may be able to infer that the mobile device is placed with its display down upon a flat surface based upon modality information obtained from the gyroscope 322 or from the ambient light sensor 326, or from both or from other sensors, etc. Based on the modality data available from the various sensors, the context engine 109 may make inferences that the user of the mobile device is walking, running, driving a car, on public transportation, in a noisy environment, at a specific location, or various other types of context inferences that may be inferred using the modality data available.

Another context example is a geo-fence context. In some embodiments, using the context module 351, the mobile device 300 user may establish a context such as a geo-fence. By specifying a location, or coordinates to establish a perimeter, a user may establish a geo-fence. A mobile device may then provide the context server 105 with GPS coordinates from the GPS hardware 315 via the modality gathering module 352 as modality information. The context server 105 may then sent a context notification when the mobile device is within the perimeter of the geo-fence.

A specific example of this is where a parent wishes to know when their children have arrived or left school. A perimeter designating the school grounds may be set as a geo-fence using the context module 351 in conjunction with the context server 105. With appropriate group and permission settings at the context server 105, when the children arrive within the geo-fence established at the context server 105, the parents who are subscribed to the appropriate group will receive a context notification from the context server 105 notifying them that their children have arrived at school. More specifically, the child's mobile device 300 modality gathering module 352 will gather location information from the GPS hardware 315 and report that along with other sensor information from the sensor processor 321 as modality information reported to the context server 105. When the context server 105 makes the association of the location information with the appropriate context established for the appropriate group, the context server 105 will send the context notification to the parents' mobile devices.

Another application may use information from the battery monitor 328. For example, there will be many instances where the mobile device 300 battery power would not be sufficient to communicate using certain communication modes. For example, a video call may take an excessive amount of battery power which may not be available to the mobile device 300 a particular point in time. The context server 105 will receive battery information from the battery monitor 328, and can make a context inference that there is insufficient battery power for the mobile device 300 to engage in a video call. Therefore, if a user receiving context notifications for that specific mobile device attempts to establish a video call, then an appropriate notification will be displayed advising them that the user they are trying to contact does not have sufficient battery power to engage in a video phone call.

In some embodiments, individual users are able to set the context notifications that are provided to other users and may even block certain modes of communication from arriving at their mobile device. For example, a user may specify to the context server, 105 or to the context module 351, that video phone calls will not be allowed if the battery monitor 328 indicates that insufficient power is available to establish that communication mode. Such settings and preferences may be set by the user and stored in the memory 340 as data 343. The data 343 may be accessible by the context module 351 or by the context server 105, or by both. In other embodiments, the context server 105 may store such user preferences and settings and send notification messages based upon those preferences and settings.

Various other types of context applications may become apparent to those of ordinary skill in light of the above disclosure and such context applications are contemplated by the various embodiments disclosed and described in the present disclosure.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. An apparatus comprising:
a transceiver;
a display;
a processor, operatively coupled to the transceiver and to the display, the processor operative to:
interrupt a communication application by displaying a context notification within a graphical user interface (GUI) of the communication application on the display.

2. The apparatus of claim 1, wherein the processor is further operative to:
prevent user input to the communication application until a user selection input is received within the context notification on the GUI.

3. The apparatus of claim 1, wherein the processor is further operative to:
display the context notification within a dialog box on the GUI.

4. The apparatus of claim 1, wherein the processor is further operative to:
interrupt the communication application where the communication application is being executed by the processor.

5. The apparatus of claim 1, wherein the processor is further operative to:
interrupt the communication application in response to receiving the context notification from a server.

6. The apparatus of claim 1, wherein the processor is further operative to:
interrupt the communication application where the communication application is a dialer, a short-message-service (SMS) application or an instant-messaging (IM) application.

7. The apparatus of claim 1, wherein the processor is further operative to:
display the context notification in a dialog box.

8. The apparatus of claim 7, wherein the processor is further operative to:
display the dialog box overlaying the communication application GUI such that the communication application GUI cannot be accessed.

9. The apparatus of claim 8, wherein the processor is further operative to:
clear the dialog box to enable access to the communication application GUI in response to user selection input within the dialog box.

10. The apparatus of claim 2, wherein the processor is further operative to:
launch a different communication application from the interrupted communication application in response to the user selection input received within the context notification on the interrupted communication application GUI.

11. A method comprising:
interrupting a communication application running on a mobile device; and
displaying a context notification within a graphical user interface (GUI) of the communication application on a display of the mobile device, where the context notification is interrupting the communication application.

12. The method of claim 11, further comprising:
preventing user input to the communication application until a user selection input is received within the context notification on the GUI.

13. The method of claim 11, further comprising:
displaying the context notification within a dialog box on the GUI.

14. The method of claim 11, further comprising:
interrupting the communication application where the communication application is being executed by a processor of the mobile device.

15. The method of claim 11, further comprising:
interrupting the communication application in response to receiving the context notification from a server.

16. The method of claim 11, further comprising:
interrupting the communication application where the communication application is a dialer, a short-message-service (SMS) application or an instant-messaging (IM) application.

17. The method of claim 11, further comprising:
displaying the context notification in a dialog box.

18. The method of claim 17, further comprising:
displaying the dialog box overlaying the communication application GUI such that the communication application GUI cannot be accessed.

19. The method of claim 18, further comprising:
clearing the dialog box to enable access to the communication application GUI in response to user selection input within the dialog box.

20. The method of claim 12, further comprising:
launching a different communication application from the interrupted communication application in response to the user selection input received within the context notification on the interrupted communication application GUI.

21. An apparatus comprising:
a network interface, operative to implement an Internet Protocol (IP) connection;
a processor, operatively coupled to the network interface, where the processor is operative to:
receive modality information from a plurality of mobile devices;
analyze the modality information of each mobile device to make a context inference for each mobile device;
send a context notification over the IP connection to subscribed mobile devices that are subscribed to receive context notifications from other mobile devices.

22. An apparatus of claim 21, wherein the processor is further operative to:
receive the modality information from a plurality of mobile devices, where the modality information comprises sensor data from a plurality of mobile device sensors.
